(19) United States
(12) Patent Application Publication
(10) Pub. No.: US 2014/0222539 A1
(43) Pub. Date: Aug. 7, 2014

(54) CUSTOMER LOYALTY SYSTEM

(71) Applicants: Matthew Scholz, Seattle, WA (US); Eyal Peleg, Amirim (IL); Eyal Barzilay, Netanya (IL)

(72) Inventors: Matthew Scholz, Seattle, WA (US); Eyal Peleg, Amirim (IL); Eyal Barzilay, Netanya (IL)

(21) Appl. No.: 14/130,490

(22) PCT Filed: Jun. 14, 2012
(86) PCT No.: PCT/IB12/53003

§ 371 Date: Jan. 1, 2014

Related U.S. Application Data
(60) Provisional application No. 61/497,065, filed on Jun. 15, 2011.
(60) Provisional application No. 61/592,077, filed on Jan. 30, 2012.

(51) Int. Cl. G06Q 30/02

(52) U.S. Cl. CPC G06Q 30/0226
USPC 705/14.27

(57) ABSTRACT

A customer loyalty method including receiving transaction information associated with a transaction between a customer and a merchant, determining, in accordance with a set of predefined loyalty benefit rules associated with the merchant, a loyalty benefit associated with the transaction information, associating the loyalty benefit with a transaction identifier, receiving the transaction identifier from the customer, and crediting, to an account associated with the customer and in association with the merchant, the loyalty benefit associated with the transaction identifier received from the customer.

### CROSS-REFERENCE TO RELATED APPLICATIONS

This application claims the benefit of priority of U.S. Provisional Patent Application No. 61/497,065, filed Jun. 15, 2011, and U.S. Provisional Patent Application No. 61/592,077, filed Jan. 30, 2012, the disclosures of which are incorporated herein by reference in their entirety.

### FIELD OF THE INVENTION

The present invention relates in general to managing relationships between merchants and customers, and particularly to managing customer loyalty systems.

### BACKGROUND OF THE INVENTION

One method used by merchants to encourage repeat customer business involves establishing a loyalty program in which a customer is given a reward, such as in the form of a gift or a discount, by a merchant after having purchased goods or services from the merchant a certain number of times. Such loyalty systems are typically managed by providing the customer with a loyalty card that the merchant punches, stamps, or scans after each of the customer's transactions with the merchant, thereby crediting each transaction towards a future reward. Such systems require customers to retain and remember to bring their loyalty cards with them each time they visit the merchant. Unfortunately, customers who lose their loyalty cards might not be able to accumulate credits for their transactions, and as a result might not be able to receive their rewards.

### SUMMARY OF THE INVENTION

In one aspect of the invention a customer loyalty method is provided including receiving transaction information associated with a transaction between a customer and a merchant, determining, in accordance with a set of predefined loyalty benefit rules associated with the merchant, a loyalty benefit associated with the transaction information, associating the loyalty benefit with a transaction identifier, receiving the transaction identifier from the customer, and crediting, to an account associated with the customer and in association with the merchant, the loyalty benefit associated with the transaction identifier received from the customer.

In another aspect of the invention the method further includes providing the transaction identifier to the merchant for access by the customer.

In another aspect of the invention the method further includes representing the transaction identifier in a human-readable format.

In another aspect of the invention the method further includes representing the transaction identifier in a machine-readable format.

In another aspect of the invention the method further includes representing the transaction identifier as a bar code.

In another aspect of the invention the method further includes representing the transaction identifier as a quick response code.

In another aspect of the invention the receiving step includes receiving the transaction identifier together with a customer identifier associated with the customer.

In another aspect of the invention the method further includes identifying the customer using a caller ID protocol.

In another aspect of the invention the method further includes validating the transaction identifier received from the customer, where the crediting step is performed only if the transaction identifier is valid.

In another aspect of the invention the validating step further includes determining that the loyalty benefit associated with the transaction identifier has not yet expired or previously been redeemed.

In another aspect of the invention the method further includes sending to the customer a confirmation of the credited loyalty benefit.

In another aspect of the invention the method further includes notifying the customer when the loyalty benefit becomes redeemable.

In another aspect of the invention the method further includes receiving a redemption request associated with the customer and the merchant, sending to the merchant a list of currently-redeemable ones of the loyalty benefits that were previously credited to the account associated with the customer and in association with the merchant, receiving a notification of the redemption of one or more of the currently-redeemable ones of the loyalty benefits, and updating the account associated with the customer to reflect the redemption.

In another aspect of the invention the sending is performed responsive to receiving a request from the merchant to perform the sending.

In another aspect of the invention the method further includes associating a list identifier with the list of currently-redeemable ones of the loyalty benefits, where the sending step includes sending the list identifier to any of the merchant and the customer.

In another aspect of the invention the receiving the redemption request step includes receiving a merchant location identifier associated with the merchant, and where the sending step includes sending to a location associated with the merchant location identifier.

In another aspect of the invention the receiving the redemption request step includes receiving a customer identifier associated with the customer.

In another aspect of the invention a customer loyalty method is provided including receiving a redemption request associated with a customer and a merchant, sending to the merchant a list of currently-redeemable loyalty benefits that were previously credited to an account associated with the customer and in association with the merchant, receiving a notification of the redemption of one or more of the currently-redeemable ones of the loyalty benefits, and updating the account associated with the customer to reflect the redemption.

In another aspect of the invention the sending is performed responsive to receiving a request from the merchant to perform the sending.

In another aspect of the invention the method further includes associating a list identifier with the list of currently-redeemable ones of the loyalty benefits, where the sending step includes sending the list identifier to the any of merchant and the customer.

In another aspect of the invention the receiving the redemption request step includes receiving a merchant location identifier associated with the merchant, and where the sending step includes sending to a location associated with the merchant location identifier.

In another aspect of the invention the receiving the redemption request step includes receiving a customer identifier associated with the customer.

In another aspect of the invention a customer loyalty system is provided including a transaction processor configured to receive transaction information associated with a transaction between a customer and a merchant, and a loyalty benefit processor configured to determine, in accordance with a set of predefined loyalty benefit rules associated with the merchant, a loyalty benefit associated with the transaction information, and associate the loyalty benefit with a transaction identifier, where the transaction processor is configured to receive the transaction identifier from the customer, and where the loyalty benefit processor is configured to credit, to an account associated with the customer and in association with the merchant, the loyalty benefit associated with the transaction identifier received from the customer.

In another aspect of the invention the transaction processor is configured to provide the transaction identifier to the merchant.

In another aspect of the invention the transaction processor is configured to represent the transaction identifier in a human-readable format.

In another aspect of the invention the transaction processor is configured to represent the transaction identifier in a machine-readable format.

In another aspect of the invention the transaction processor is configured to represent the transaction identifier as a bar code.

In another aspect of the invention the transaction processor is configured to represent the transaction identifier as a quick response code.

In another aspect of the invention the transaction processor is configured to receive the transaction identifier together with a customer identifier associated with the customer.

In another aspect of the invention the transaction processor is configured to identify the customer using a caller ID protocol.

In another aspect of the invention the loyalty benefit processor is configured to validate the transaction identifier received from the customer, where the customer account is credited only if the transaction identifier is valid.

In another aspect of the invention the loyalty benefit processor is configured to determine that the loyalty benefit associated with the transaction identifier has not yet expired or previously been redeemed.

In another aspect of the invention the transaction processor is configured to send to the customer a confirmation of the credited loyalty benefit.

In another aspect of the invention the transaction processor is configured to notify the customer when the loyalty benefit becomes redeemable.

In another aspect of the invention the transaction processor is configured to receive a redemption request associated with the customer and the merchant, send to the merchant a list of currently-redeemable ones of the loyalty benefits that were previously credited to the account associated with the customer and in association with the merchant, and receive a notification of the redemption of one or more of the currently-redeemable ones of the loyalty benefits, and where the loyalty benefit processor is configured to update the account associated with the customer to reflect the redemption.

In another aspect of the invention the transaction processor is configured to send the list of currently-redeemable ones of the loyalty benefits responsive to receiving a request from the merchant to perform the sending.

In another aspect of the invention the transaction processor is configured to associate a list identifier with the list of currently-redeemable ones of the loyalty benefits and send the list identifier to any of the merchant and the customer.

In another aspect of the invention the redemption request includes a merchant location identifier associated with the merchant, and where the transaction processor is configured to send the list of currently-redeemable ones of the loyalty benefits to a location associated with the merchant location identifier.

In another aspect of the invention the redemption request includes a customer identifier associated with the customer.

In another aspect of the invention a customer loyalty system is provided including a transaction processor configured to receive a redemption request associated with a customer and a merchant, send to the merchant a list of currently-redeemable loyalty benefits that were previously credited to an account associated with the customer and in association with the merchant, and receive a notification of the redemption of one or more of the currently-redeemable ones of the loyalty benefits, and a loyalty benefit processor configured to update the account associated with the customer to reflect the redemption.

In another aspect of the invention the transaction processor is configured to send the list of currently-redeemable ones of the loyalty benefits responsive to receiving a request from the merchant to perform the sending.

In another aspect of the invention the transaction processor is configured to associate a list identifier with the list of currently-redeemable ones of the loyalty benefits and send the list identifier to any of the merchant and the customer.

In another aspect of the invention the redemption request includes a merchant location identifier associated with the merchant, and where the transaction processor is configured to send the list of currently-redeemable ones of the loyalty benefits to a location associated with the merchant location identifier.

In another aspect of the invention the redemption request includes a customer identifier associated with the customer.

### BRIEF DESCRIPTION OF THE DRAWINGS

The invention will be understood and appreciated more fully from the following detailed description taken in conjunction with the appended drawings in which:

FIG. 1 is a simplified conceptual illustration of a customer loyalty system, constructed and operative in accordance with an embodiment of the invention; and

FIGS. 2A, 2B, and 2C are simplified action diagrams of exemplary methods of operation of the system of FIG. 1, operative in accordance with embodiments of the invention.

### DETAILED DESCRIPTION OF THE INVENTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

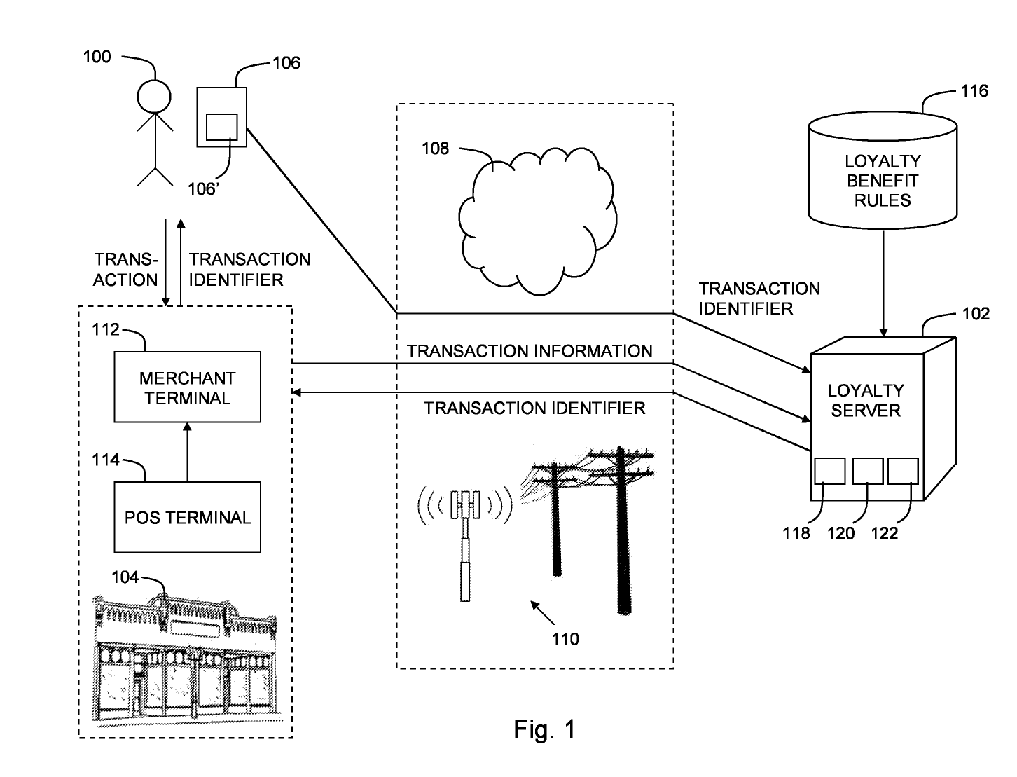

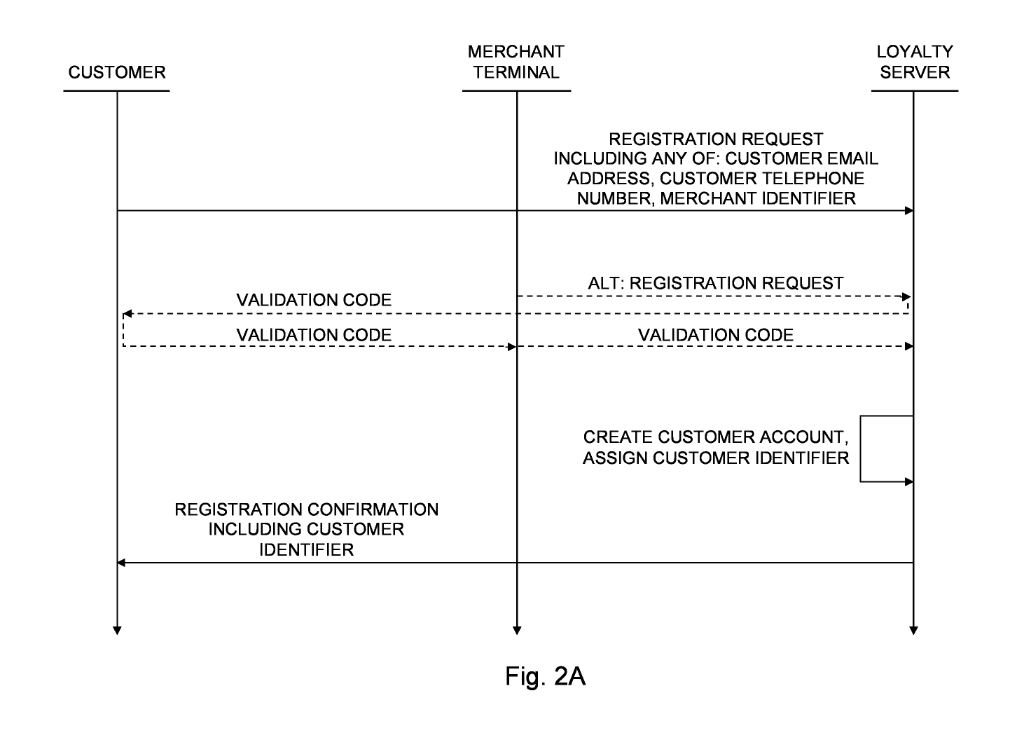

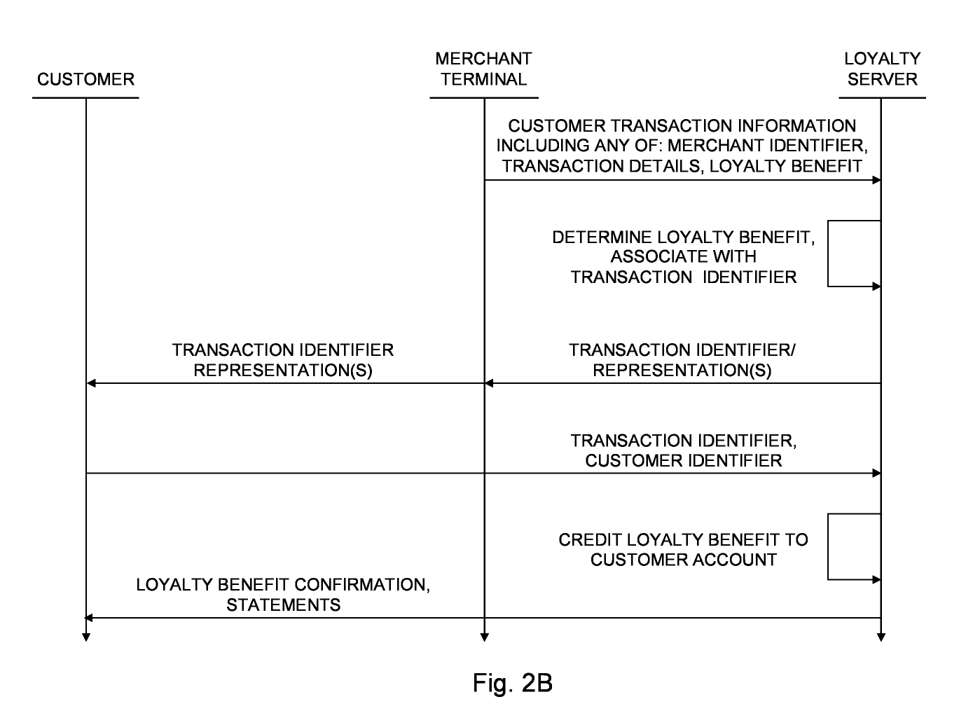

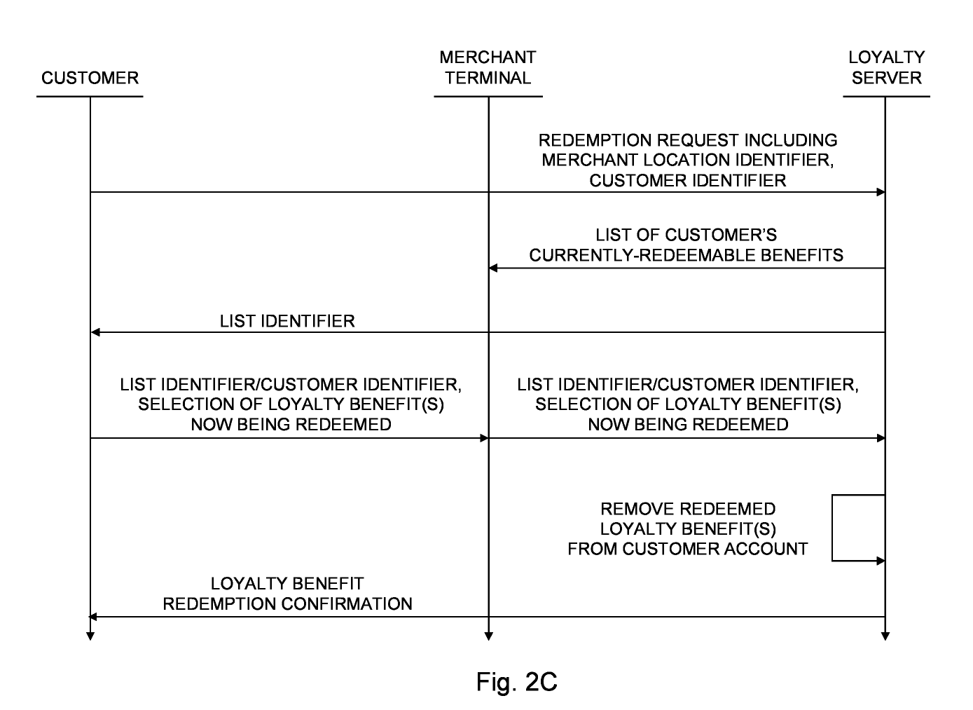

Reference is now made to FIG. 1, which is a simplified conceptual illustration of a customer loyalty system, constructed and operative in accordance with an embodiment of the invention, and additionally to FIGS. 2A, 2B, and 2C which are simplified action diagrams of exemplary methods of operation of the system of FIG. 1, operative in accordance with embodiments of the invention.

### Customer Registration

In the system of FIG. 1 and method of FIG. 2A, a customer 100 sends a registration request to a loyalty server 102 to maintain a relationship between customer 100 and one or more merchants, such as a merchant 104. Customer 100 preferably communicates with loyalty server 102 using a communications device 106, such as may be a computer or a telephone or a combination thereof, that is configured to communicate with loyalty server 102 via a computer network 108, such as the Internet, and/or via a telephone network 110, such as a land-based or cellular telephone network. Communications device 106 may communicate with loyalty server 102 by accessing a network-accessible interface, such as a web-based interface, that is provided by loyalty server 102 at a network address that is made known to customer 100 or communications device 106 using conventional techniques. Additionally or alternatively, communications device 106 may communicate with loyalty server 102 via a software application 106′ that is preconfigured to communicate with loyalty server 102 and that is preinstalled on communications device 106, or that may be downloaded to and installed on communications device 106 using conventional techniques. Additionally or alternatively, communications device 106 may communicate with loyalty server 102 using a communications protocol such as the Short Message Service (SMS), which may be accessed at a telephone number that is associated with loyalty server 102 and that may be additionally associated with a specific merchant.

The registration request that customer 100 sends to loyalty server 102 preferably includes an email address associated with customer 100 and a telephone number associated with customer 100, where the telephone number may be communicated to loyalty server 102 using a caller ID protocol if communications device 106 communicates the registration request via telephone network 110. Customer 100 may additionally provide other information to loyalty server 102, such as customer 100's name and birth date, either together with the registration request or separately at a later time. Any information relating to customer 100 that is received by loyalty server 102 may be validated using any known validation technique, such as where the information is sent to customer 100 for which a validation reply is requested, such as to customer 100's telephone number, such as using SMS, or customer 100's email address, or by communicating directly with software application 106′ at communications device 106. If customer 100 is not known to loyalty server 102, loyalty server 102 preferably creates a new account for the customer, where loyalty server 102 preferably generates a unique customer identifier and associates the customer identifier with the customer account. Loyalty server 102 preferably sends a confirmation of the customer account creation, including the customer identifier, to customer 100, such as to customer 100's telephone number using SMS, or to customer 100's email address, or by communicating directly with software application 106′ at communications device 106 for storage thereat.

The registration request that customer 100 sends to loyalty server 102 preferably includes the identity of a specific merchant, such as merchant 104, thereby requesting that loyalty server 102 maintain a relationship between customer 100 and the specific merchant. Alternatively, the registration request that customer 100 sends to loyalty server 102 does not include the identity of a specific merchant, in which case loyalty server 102 may begin to maintain a relationship between customer 100 and a specific merchant at a later time if and when customer 100 provides the identity of a specific merchant.

In an alternative embodiment, customer 100 does not use communications device 106 to send the registration request to loyalty server 102. Rather, a merchant terminal 112 is used to communicate the registration request to loyalty server 102, where the registration request includes the email address or telephone number of customer 100 at communications device 106. Loyalty server 102 then sends a validation code to communications device 106, such as via email or SMS, whereupon customer 100 provides the validation code for input into merchant terminal 112, which transmits the validation code to loyalty server 102 to complete the registration of customer 100.

### Determining Loyalty Benefits

In the system of FIG. 1 and method of FIG. 2B, when customer 100 transacts with merchant 104, such as to purchase goods or services, merchant terminal 112 is used, such as by a cashier at merchant 104, to communicate information associated with the customer transaction to loyalty server 102. Merchant terminal 112 may, in addition to operating as described herein, be configured to operate as a point-of-sale (POS) terminal that is used to record the customer transaction, or may operate separately from a POS terminal 114 that records the customer transaction, in which case POS terminal 114 preferably provides details of the customer transaction to merchant terminal 112. The customer transaction information communicated by merchant terminal 112 preferably includes an identifier identifying merchant 104, as well as details of the customer transaction that are required by loyalty server 102 to determine a loyalty benefit in accordance with a set of predefined loyalty benefit rules 116 that are associated with merchant 104. For example, if loyalty benefit rules 116 indicate that customers of merchant 104 are to receive a loyalty benefit of a free cup of coffee after purchasing nine cups of coffee, and a given customer transaction at merchant 104 includes the purchase of a cup of coffee, the related customer transaction information communicated by merchant terminal 112 should indicate the purchase of a cup of coffee. Additionally or alternatively, merchant terminal 112 may access loyalty benefit rules 116 or a copy thereof, calculate a loyalty benefit based on the details of a customer transaction, such as one-ninth of a cup of coffee based on the previous example of the purchase of one cup of coffee, and communicate the loyalty benefit to loyalty server 102 as part of the customer transaction information. The customer transaction information communicated by merchant terminal 112 to loyalty server 102 may optionally include other types of information, such as an identifier of a store or location where the customer transaction occurred, an identifier of a POS terminal that processed the customer transaction, an identifier of a cashier that processed the customer transaction, the date and time of customer transaction, the items purchased and the transaction amount. The customer transaction information communicated by merchant terminal 112 to loyalty server 102 may optionally include customer 100's identifier and/or other customer-related information that customer 100 may provide for input to merchant terminal 112, either manually, or by displaying such information on communications device 106 in human-readable and/or machine-readable formats for scanning by merchant terminal 112 as described in greater detail hereinbelow, or using near-field communications (NFC) or any other wireless communications protocol.

After receiving customer transaction information communicated by merchant terminal 112, loyalty server 102 preferably generates a unique transaction identifier and associates the transaction identifier with the customer transaction. Loyalty server 102 is also preferably configured to determine a loyalty benefit in accordance with loyalty benefit rules 116 using the details of the customer transaction information. The loyalty benefit, which may, for example, include free items or purchase discounts, is then maintained by loyalty server 102 in association with the transaction identifier. If the customer transaction information includes customer 100's identifier, or loyalty server 102 is able to determine customer 100's identifier from other customer-related information included in or associated with the customer transaction information, loyalty server 102 preferably credits the loyalty benefit to the account of customer 100 in association with merchant 104. Otherwise, loyalty server 102 may represent the transaction identifier in a human-readable format using alphanumeric characters or other symbols and/or in a machine-readable format such as a one-dimensional symbol, such as a bar code, or a two-dimensional symbol or matrix code, such as a quick response (QR) code, and communicate any or all of the representations of the transaction identifier to merchant terminal 112. Additionally or alternatively, merchant terminal 112 may be configured to receive the transaction identifier in any format from loyalty server 102 and represent the transaction identifier as described hereinabove.

Merchant terminal 112 is preferably configured to print and/or display and/or otherwise provide, such as using near-field communications (NFC) or other wireless communications protocol, any or all of the representations of the transaction identifier, and/or provide any or all of the representations of the transaction identifier to POS terminal 114 to be printed and/or displayed and/or wirelessly communicated thereby, such as where any or all of the representations of the transaction identifier are printed on a transaction receipt and/or displayed on a computer display. The printed and/or displayed representations of the transaction identifier are provided to customer 100, who then enters the transaction identifier into communications device 106 using any input technique, such as via keyboard input or wireless receiver or optical scanning using a camera or other optical scanner that is configured with communications device 106. Customer 100 may then use communications device 106 to send the transaction identifier to loyalty server 102 using any of the communications methods described hereinabove, preferably together with customer 100's identifier as may be stored by software application 106′ or otherwise entered into communications device 106 using any input technique, and/or where loyalty server 102 determines customer 100's identifier as being associated with customer 100's telephone number which loyalty server 102 determines using caller ID protocols.

After receiving the transaction identifier communicated by communications device 106 and receiving or determining the identifier of customer 100 as having provided the transaction identifier, loyalty server 102 preferably credits the loyalty benefit to the account of customer 100 in association with merchant 104, preferably after determining that the transaction identifier is valid using any validation technique, and that the loyalty benefit associated with the transaction identifier has not yet expired or previously been redeemed. Loyalty server 102 preferably sends a confirmation of the newly-credited loyalty benefit to customer 100, such as to customer 100's telephone number, such as using SMS, or customer 100's email address, or by communicating directly with software application 106′ at communications device 106 for storage thereat. Additionally or alternatively loyalty server 102 may periodically send statements to customer 100, using any of the communications methods described hereinabove, indicating what loyalty benefits customer 100 has earned and for which merchants. Additionally or alternatively loyalty server 102 may notify customer 100, using any of the communications methods described hereinabove, that a particular loyalty benefit earned by customer 100 may be redeemed, such as after customer 100 earns a free cup of coffee after purchasing his/her ninth cup of coffee as per the example above.

### Redeeming Loyalty Benefits

In the system of FIG. 1 and method of FIG. 2C, customer 100 may redeem a loyalty benefit with respect to a specific a merchant location, whether or not customer 100 is physically at the merchant location, by entering a merchant location identifier, such as in the form of an identifier of merchant terminal 112, POS terminal 114, or of the merchant location itself, into communications device 106 using any input technique as described hereinabove, or by selecting such information using software application 106′ from a predefined list of merchant locations that is configured with software application 106′ or that is otherwise accessible to software application 106′, such as by accessing a web-based list that is provided by loyalty server 102. Customer 100 may then use communications device 106 to send the merchant location identifier as part of a redemption request to loyalty server 102 using any of the communications methods described hereinabove, together with customer 100's identifier or otherwise in a manner such that customer 100 may be identified as described hereinabove.

After receiving the redemption request, and preferably after receiving a request from the merchant to do the following, loyalty server 102 preferably sends a list of customer 100's currently-redeemable (i.e., not expired or otherwise invalid) loyalty benefits to merchant terminal 112, POS terminal 114, or any other terminal at the merchant location as may be predefined and made known to loyalty server 102. Loyalty server 102 may generate and associate a temporary list identifier with the list and provide the list identifier together with the list, as well as communicate the list identifier separately to customer 100 using any of the communications methods described hereinabove, while maintaining an association between the list identifier and customer 100's identifier. Customer 100 may provide the list identifier to a cashier at the merchant location to help the cashier find the list of customer 100's currently-redeemable loyalty benefits. Customer 100 may then indicate to the cashier which loyalty benefit customer 100 wishes to redeem, which the cashier may then carry out and remove from the list or otherwise mark as redeemed. Additionally or alternatively, loyalty server 102 may provide customer 100's identifier and/or other information identifying customer 100 together with the list, which customer 100 may provide to a cashier at the merchant location to help the cashier find the list of customer 100's currently-redeemable loyalty benefits.

The details of the loyalty benefit redemption are preferably communicated by merchant terminal 112 to loyalty server 102, such as in the manner described hereinabove regarding customer transactions, together with the list identifier and/or customer 100's identifier, as well as the merchant identifier. Loyalty server 102 then updates customer 100's account to reflect the redemption of the loyalty benefit. Loyalty server 102 preferably sends a confirmation of the recently redeemed loyalty benefit to customer 100 using any communications methods described hereinabove. If, in addition to the redeemed loyalty benefit, the customer transaction as reported to loyalty server 102 includes other purchased items, merchant terminal 112 and/or loyalty server 102 may determine any new loyalty benefit as described hereinabove and credit the new loyalty benefit directly to customer 100's account, without generating a transaction identifier.

All operations performed by loyalty server 102 with respect to customer registration as described hereinabove may be performed by a registration processor 118 that is configured with loyalty server 102. All operations performed by loyalty server 102 with respect to determining or validating loyalty benefits and crediting or updating customer accounts as described hereinabove may be performed by a loyalty benefit processor 120 that is configured with loyalty server 102. All other operations performed by loyalty server 102 as described hereinabove may be performed by a transaction processor 122 that is configured with loyalty server 102.

Any data or communications described herein may be encrypted, digitally signed, verified, and/or validated using any conventional techniques.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a non-transitory computer-readable medium, such as in the form of computer program instructions stored on magnetic or optical storage media or embedded within computer hardware, and may be executed by or otherwise accessible to a computer (not shown).

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1-44. (canceled)

45. A customer loyalty method comprising:
receiving transaction information associated with a transaction between a customer and a merchant;
determining, in accordance with a set of predefined loyalty benefit rules associated with the merchant, a loyalty benefit associated with the transaction information;
associating the loyalty benefit with a transaction identifier;
receiving the transaction identifier from the customer; and
crediting, to an account associated with the customer and in association with the merchant, the loyalty benefit associated with the transaction identifier received from the customer.

46. The method according to claim 45 and further comprising providing the transaction identifier to the merchant for access by the customer.

47. The method according to claim 45 wherein the receiving step comprises receiving the transaction identifier together with a customer identifier associated with the customer.

48. The method according to claim 45 and further comprising validating the transaction identifier received from the customer, wherein the crediting step is performed only if the transaction identifier is valid.

49. The method according to claim 48 wherein the validating step further includes determining that the loyalty benefit associated with the transaction identifier has not yet expired or previously been redeemed.

50. The method according to claim 45 and further comprising sending to the customer a confirmation of the credited loyalty benefit.

51. The method according to claim 45 and further comprising notifying the customer when the loyalty benefit becomes redeemable.

52. The method according to claim 45 and further comprising:
receiving a redemption request associated with the customer and the merchant;
sending to the merchant a list of currently-redeemable ones of the loyalty benefits that were previously credited to the account associated with the customer and in association with the merchant;
receiving a notification of the redemption of one or more of the currently-redeemable ones of the loyalty benefits; and
updating the account associated with the customer to reflect the redemption.

53. The method according to claim 52 and further comprising associating a list identifier with the list of currently-redeemable ones of the loyalty benefits, wherein the sending step comprises sending the list identifier to any of the merchant and the customer.

54. The method according to claim 52 wherein the receiving the redemption request step includes receiving a merchant location identifier associated with the merchant, and wherein the sending step comprises sending to a location associated with the merchant location identifier.

55. A customer loyalty system comprising:
a transaction processor configured to receive transaction information associated with a transaction between a customer and a merchant; and
a loyalty benefit processor configured to
determine, in accordance with a set of predefined loyalty benefit rules associated with the merchant, a loyalty benefit associated with the transaction information, and
associate the loyalty benefit with a transaction identifier,
wherein the transaction processor is configured to receive the transaction identifier from the customer, and
wherein the loyalty benefit processor is configured to credit, to an account associated with the customer and in association with the merchant, the loyalty benefit associated with the transaction identifier received from the customer.

56. The system according to claim 55 wherein the transaction processor is configured to provide the transaction identifier to the merchant.

57. The system according to claim 55 wherein the transaction processor is configured to receive the transaction identifier together with a customer identifier associated with the customer.

58. The system according to claim 55 wherein the loyalty benefit processor is configured to validate the transaction identifier received from the customer, wherein the customer account is credited only if the transaction identifier is valid.

59. The system according to claim 58 wherein the loyalty benefit processor is configured to determine that the loyalty benefit associated with the transaction identifier has not yet expired or previously been redeemed.

60. The system according to claim 55 wherein the transaction processor is configured to send to the customer a confirmation of the credited loyalty benefit.

61. The system according to claim 55 wherein the transaction processor is configured to notify the customer when the loyalty benefit becomes redeemable.

62. The system according to claim 55
wherein the transaction processor is configured to
receive a redemption request associated with the customer and the merchant,
send to the merchant a list of currently-redeemable ones of the loyalty benefits that were previously credited to the account associated with the customer and in association with the merchant, and
receive a notification of the redemption of one or more of the currently-redeemable ones of the loyalty benefits, and
wherein the loyalty benefit processor is configured to update the account associated with the customer to reflect the redemption.

63. The system according to claim 62 wherein the transaction processor is configured to associate a list identifier with the list of currently-redeemable ones of the loyalty benefits and send the list identifier to any of the merchant and the customer.

64. The system according to claim 62 wherein redemption request includes a merchant location identifier associated with the merchant, and wherein the transaction processor is configured to send the list of currently-redeemable ones of the loyalty benefits to a location associated with the merchant location identifier.
